(19) United States
(12) Patent Application Publication
(10) Pub. No.: US 2022/0177771 A1
(43) Pub. Date: Jun. 9, 2022

(54) IRON-TOLERANT SCALE INHIBITORS

(71) Applicant: Finoric, LLC, Beasley, TX (US)

(72) Inventors: Deepak Patil, Friendswood, TX (US); Ambrish Kamdar, Beasley, TX (US)

(73) Assignee: Finoric, LLC, Beasley, TX (US)

(21) Appl. No.: 17/546,815

(22) Filed: Dec. 9, 2021

Related U.S. Application Data
(60) Provisional application No. 63/123,190, filed on Dec. 9, 2020.

(51) Int. Cl. C09K 8/528

(52) U.S. Cl. CPC C09K 8/528; C09K 2208/32

(57) ABSTRACT

Embodiments of the invention comprise compositions and methods for inhibiting the formation of scales in wellbore environments with high levels of dissolved iron. The composition comprises compounds made with sugar acids, such as aldonic acids, ulosonic acids, uronic acids, and/or aldaric acids, and/or salts, esters, and ethers thereof. These sugar acids can be used in conjunction with conventional threshold scale inhibitors, comprising phosphonates, phosphates, aminocarboxylates, amino acids, and polymers containing carboxylic acids, sulfonic acids, phosphonates, phosphates. The resulting scale inhibition mixture minimizes scale formation from various cations while simultaneously acting as a chelating agent.

### REFERENCE TO RELATED APPLICATIONS

This is a US patent application claiming benefit and priority from U.S. Provisional Application 63/123,190, filed 9 Dec. 2020, with the same title and inventors. The full contents of the above-referenced application are incorporated herein by reference.

### FIELD

The application relates, generally, to downhole additives for oil and gas production. More specifically, the application relates to additives containing sugar acids for inhibiting the formation of “scale” precipitation in wellbores.

### BACKGROUND

The formation of inorganic salt precipitates, also known as “scales,” is a common problem in oil and gas production and processing operations. During the production of oil and gas, water is also produced. This produced water often contains high concentrations of metal cations such as sodium, calcium, strontium, iron and barium, along with anions such as hydroxide, carbonate, bicarbonate, sulfide and sulfate. Additional iron is also formed due to corrosion of well tubulars. Typically, oil or gas production and processing systems involve abrupt physical changes such as a change in temperature or pressure, or a mixing of immiscible fluids, and there is a thermodynamic driving force for these ions to precipitate as inorganic salts.

The scales, as disclosed above are known to form near the wellbore, inside casing, tubing, pipes, pumps and valves, and around heating coils. Reduction of wellbore permeability, reduction of perforation diameter, reduction of production tubing diameter, and reduction of propped fracture conductivity can significantly reduce well productivity. Scale formation has detrimental effects to surface equipment, such as transmission lines, separators, etc., as well. Over time, large scale deposits can reduce fluid flow and heat transfer as well as promote corrosion and bacterial growth. As the deposits grow, the production rate decreases and may even force the whole operation to halt in order to remediate the wellbore.

Removal of scales often requires expensive well interventions involving bullhead or coil tubing placement of scale dissolving chemical treatments, milling operations, or re-perforation. Economically efficient scale management predominantly involves the application of chemical scale inhibitors that prevent scale deposition. Scale inhibitors are conventionally applied during completion operations or as a downhole injection or a squeeze treatment.

Scale inhibitors are chemical agents that catalytically prevent scale precipitation, even when the brine or other fluid is oversaturated. These chemicals are referred to as “threshold” scale inhibitors because they prevent nucleation and scale formation at concentrations that are far too low to be effective by stoichiometrically reacting with scale-forming ions alone, such as with chelating agents. Threshold scale inhibitors are thought to achieve scale inhibition by adsorbing onto specific crystallographic planes of a growing crystal nucleus after a nucleation event. This adsorption prevents further crystal growth and agglomeration.

Many aminophosphonate-based, scale inhibitors are known to the art. Examples of such scale inhibitors (incorporated herein by reference) are disclosed in U.S. Pat. No. 3,434,969 (filed Aug. 11, 1967), U.S. Pat. No. 4,080,375 (filed Oct. 15, 1976), U.S. Pat. No. 4,931,189 (filed Jun. 15, 1989); U.S. Pat. No. 5,338,347 (filed May 11, 1992).

Similarly, polymeric scale inhibitors are known to the art. Examples of such scale inhibitors (incorporated herein by reference) are disclosed in US 2012/0118575, (filed Nov. 11, 2011) where the monomers are selected from maleic acid, maleic anhydride, fumaric acid, vinyl sulfonic acid, allyl sulfonic acid, methallylsulfonic acid, vinyl phosphonate, allyl phoshonate, methallyl phoshonate, and salts thereof.

However, the application of these prior art inhibitors are problematic when the brines contain dissolved iron. Iron has been observed to have a deleterious effect on the performance of scale inhibitors. This problem is illustrated by the following industry publications: G. M. Graham et al., “The Impact of Dissolved Iron on the Performance of Scale Inhibitors Under Carbonate Scaling Conditions,” Paper SPE 80254 presented at the International Symposium on Oilfield Chemistry, Houston, February 5-7; H. Guan et al., “Inhibitor Selection for Iron-Scale Control in MEG Regeneration Process,” November 2009 SPE Production & Operations.

In particular, it has been found that many phosphonate-based scale inhibitors are ineffective in the presence of iron. See, e.g., Johnson, T. et al., “Phosphonate Based Scale Inhibitors for High Iron and High Salinity Environments,” Presented in Session 6 of the Royal Society of Chemistry Conference on Chemistry in the Oil Industry Manchester, UK, 31 October 2; Kriel, B. G. et al., “The Effect of Soluble Iron on the Performance of Scale inhibitors in the Inhibition of Calcium Carbonate Scales,” Paper No. 44, presented at the NACE International CORROSION 94 March 1994; Coleman et al., “Iron Release Following Scale Inhibitor Application and Mineral Dissolution in a North Alaskan Reservoir-Some Field Implications,” paper presented at the SPE International Symposium on Oilfield Scale, Aberdeen, U K, 1999.

A need therefore exists within the industry for an improved threshold scale inhibitor whose performance is not itself inhibited in oilfield waters with high levels of dissolved iron.

Embodiments disclosed in this application meet these needs.

### SUMMARY

The present invention is directed to a new method of use for sugar acids that not only perform as threshold scale inhibitors but also as chelating agents. These sugar acids can include, but are not limited to: aldonic acids, ulosonic acids, uronic acids, and/or aldaric acids, as well as salts, esters, and ethers thereof.

### DRAWINGS

FIG. 1 shows the general formula and chemical structures of several common sugar acids.

FIG. 2 shows the DSL performance of aminotrismethylene phosphonate (AMTP) from 10 to 25 ppm.

FIG. 3 shows the DSL performance of an embodiment of the inventive composition from 1 to 10 ppm.

Embodiments below are described with reference to the above drawings.

### DETAILED DESCRIPTION

Before describing selected embodiments of the present disclosure in detail, it is to be understood that the present invention is not limited to the particular embodiments described herein. The disclosure and description herein is illustrative and explanatory of one or more presently preferred embodiments and variations thereof, and it will be appreciated by those skilled in the art that various changes in the design, organization, means of operation, structures and location, methodology, and use of chemical equivalents may be made without departing from the spirit of the invention.

Conventional phosphate scale inhibitor products, marketed as well treatment compositions containing various phosphonate and phosphate containing monomers and polymers, include but are not limited to: dimethyl methylphosphonate (DMMP); etidronic acid (HEDP); 1-hydroxyethylidene-1,1-diphosphonic acid; aminotris methylenephosphonic acid (ATMP); ethylenediaminetetra methylenephosphonic acid (EDTMP); tetramethylenediaminetetra methylenephosphonic acid (TDTMP); hexamethylenediaminetetra-methylenephosphonic acid (HDTMP); diethylene triaminepentamethylene phosphonic acid (DTPMP); phosphonobutanetricarboxylic acid (PBTC); N-(phosphonomethyl)iminodiacetic acid (PMIDA); 2-carboxyethyl phosphonic acid (CEPA); 2-Hydroxyphosphonocarboxylic acid (HPAA); N,N-Bis(phosphonomethyl)glycine (BPMG); phosphino carboxylic acid (PCA); bishexamethylenetriaminopentamethylenephosphonate (BHMT); aminoethylethanolamine phosphate, and salts of the above-listed substances produced by neutralization reaction with ammonia, earth hydroxides such as sodium hydroxide or potassium hydroxide, amines such as triethanol amine, and other suitable alkalines.

Conventional polymeric scale inhibitor products, marketed as well treatment compositions containing various carboxylates include, but are not limited to: sulfonates and phosphonates containing monomers, polymers, and co-, ter- and homo-polymers comprising acrylic acid, acrylamide, maleic acid, maleic anhydride, fumaric acid, vinyl sulfonic acid, allyl sulfonic acid, methallylsulfonic acid, vinyl phoshonate, allyl phoshonate, and methallyl phosphonate.

Conventional chelating agents marketed as well treatment compositions, alone or in combination with the above conventional scale inhibitors, include but are not limited to: ethylenediaminetetraacetic acid; diethylenetriaminepentaacetic acid; N,N-Dicarboxymethyl glutamic acid tetrasodium salt (GLDA); and amino acids such as glycine, alanine, serine, glutamine, threonine, leucine, tyrosine and tryptophan.

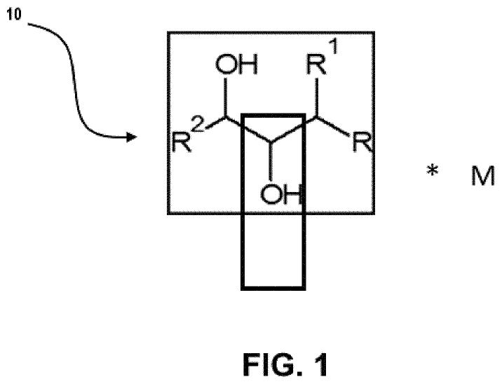

It has been discovered that sugar acids (SA) are not only iron tolerant chelants themselves, but these sugar acids can also permit conventional phosphonate and polymeric scale inhibitors, and well treatment compositions thereof, to tolerate the presence of iron compounds. Sugar acids are reaction products of various sugars, where the reactions can include direct oxidation, hydrolysis of cyanohydrins after reacting with cyanide, hydrolysis of lactones, and other suitable processes. Base sugars from which suitable acids can be derived include, but are not limited to: erythrose, threose, ribose, arabinose, xylose, lyxose, allose, altrose, glucose, mannose, gulose, idose, galactose, talose, fructose, glucopyranose, galactopyranose, mannopyranose, allopyranose, maltose, sucrose, and glucoheptonic acid. The structure of these exemplar sugar acids is depicted in FIG. 1.

In an embodiment of the present invention, a well treatment composition is made by blending sugar acids with phosphonates and/or polymeric scale inhibitors. The present invention encompasses mixtures in which at least one sugar acid, acting as an iron tolerant scale inhibitor, is present in an amount substantially between about 0.001% to about 100% by weight, and preferably about 1% to about 90% by weight, and more preferably about 10% to about 50% by weight of the mixture, and all subranges therebetween, whereas phosphonates and/or polymeric scale inhibitors are present in an amount substantially between about 0.0001% to about 99.999% by weight, preferably about 1% to about 50% by weight, and all subranges therebetween. Thus, the present invention contemplates overall formulations comprising sugar acids present in an amount that is generally between about 0.0001% to about 100% by weight, and preferably about 0.01% to about 99% by weight, of the mixture and all subranges therebetween.

In another embodiment, the sugar acids of the present invention are dissolved in an aqueous well treatment fluid in a concentration between about 0.1 ppm to about 3000 ppm, based on the weight of the aqueous treatment fluid. In another embodiment, the sugar acid is dissolved into an aqueous treatment fluid between about 1 ppm to about 100 ppm based on the weight of the aqueous fluid.

In another embodiment, the sugar acids of the present invention are initially dissolved in the form of precursor compounds, such as salts, esters, or ethers thereof, for instance, where the reaction may need to be time-controlled to introduce a delay.

In another embodiment, sugar acid is blended with a conventional phosphonate scale inhibitor such as ATMP to about 3 ppm based on the weight of the aqueous fluid. In another exemplar embodiment, sugar acid is blended with a conventional phosphonate scale inhibitor such as BHMT to about 15 ppm to control scale formation. In another exemplar embodiment, sugar acid is blended with a conventional polymeric scale inhibitor such as Flosperse 1000A™, available from SNF, Inc., of Riceboro, Ga., which comprises a co-polymer of acrylic acid and sodium acrylate. The above-listed exemplar embodiments were tested using Wolfcamp oilfield brine as described below with total dissolved solids (TDS) greater than 125,000 PPM, hardness greater than 6,000 ppm, and a concentration of dissolved iron greater than 85 ppm.

The following examples describe various embodiments of the present invention. Other embodiments within the scope of the claims will be apparent to those skilled in the art.

### Static Bottle Test

A static bottle test was conducted to show the scale inhibition properties of sugar acid for scale inhibition in the presence of dissolved iron. In this test, two incompatible waters with the tendency to form a scale were combined in a glass bottle, heated and then observed for scale precipitation.

Synthetic brine was made from an anionic water (AW) component and a cationic water (CW) component. Each of the AW and CW brines contained twice the concentration of the anionic and cationic salt, respectively, as well as the original concentration of sodium chloride. When the AW and CW brines were mixed at a 1:1 ratio, they produced a brine with the desired amount of total dissolved solids (TDS).

### Dynamic Scale Tube Blocking Test

In an embodiment of the invention, a dynamic tube blocking test (TBT) utilizing a dynamic scale loop (DSL) apparatus was used to evaluate the efficiency of sugar acid based scale inhibitors in preventing the formation and deposition of mineral scales. The TBT test aids in the determination of the minimum inhibitor concentration (MIC) required to prevent the formation of scale, and allows for the evaluation of the comparative testing of different inhibitors under similar conditions. Inhibitor efficiency is measured by the ratio of the time needed to block the tube in the presence of inhibitor divided by the time needed to block the tube in the absence of inhibitor, i.e. blank time. Conditions for the blank test are adjusted to induce significant precipitation in a reasonable time frame. The main adjusting parameters are the solution's degree of saturation of scaling species and the flow rate.

The dynamic tube blocking test was used to examine the performance of sugar acid additives alongside various conventional scale inhibitors at 65° C. For scale-inhibition testing, a synthetic brine was made from an anionic water component and a cationic water component. Each of the AW and CW brines contained twice the concentration of the anionic and cationic salt, respectively, as well as the original concentration of sodium chloride. When the AW and CW brine were mixed at a 1:1 ratio, they produced a brine with the desired composition of the high TDS water, except for the bicarbonate.

The AW and CW brines were continuously sparged with a combination of 99.0% oxygen-free nitrogen and 1.0% CO2 to remove oxygen and to adjust the brine pH to around 7.7. The bicarbonate concentration was increased to increase the carbonate scaling tendency for the test brine. After the CW brine flow was established, then the FeCl₃ solution was added to adjust the iron content of the brine.

### Brine Preparation

The analysis of the produced water or the brine from a Wolfcamp well is shown in Table 1. Synthetic brine made for various tests was made to meet the listed parameters.

TABLE 1
Wolfcamp Well Produced Water

| Parameter | Value | |
|---|---|---|
| TDS | 125,707 | ml/L |
| pH | 7.65 | |
| Density | 1.08 | |
| Calcium | 1,923 | mg/L |
| Strontium | 536 | mg/L |
| Barium | 2 | mg/L |
| Hardness | 6,015 | ppm |
| Total Alkalinity | 492 | mg CaCO₃/L |
| Iron | 89 | ppm |

### Example 1

Wolfcamp produced water was made using AW and CW, and charged to a bottle. Next, the respective scale inhibitors were added, and the pH was adjusted from 7.5 to 7.9 with 10% caustic. The contents of the bottle were well mixed, and bottles were placed in a hot water bath for 30 minutes. The clarity of the solution was checked after 30 minutes. Unless the test water was clear, it was listed as turbid. The analysis of the produced water or the brine from a Wolfcamp well is shown in Table 1. Synthetic brine made for various tests was made to meet the listed parameters. ATMP, BHMT and Flosperse 1000 A were used as controls and blended with gluconic acid for checking the turbidity.

TABLE 2
Static bottle tests with Wolfcamp Water according to Table 1

| | | | Sugar | Clarity |
|---|---|---|---|---|
| Scale Inhibitor | Phosphonate, | Polymer, | Acid, | or |
| Composition | PPM | PPM | PPM | Turbidity |
| ATMP Phosphonate | 10 | 0 | 0 | Turbid |
| BHMT Phosphonate | 10 | 0 | 0 | Turbid |
| Flosperse 1000A | 0 | 10 | 0 | Turbid |
| ATMP + Flosperse | 5 | 5 | 0 | Slightly |
| 1000A | | | | Turbid |
| ATMP + Sugar Acid | 5 | 0 | 5 | Clear |
| Flosperse 1000A + | 0 | 5 | 5 | Clear |
| Sugar Acid | | | | |
| ATMP + Flosperse | 3 | 2 | 5 | Clear |
| 1000A + Sugar Acid | | | | |

As shown in Table 2, in all three cases, the additional sugar acid reduced the turbidity of the resulting solutions, indicating that the scale inhibition activity of the phosphonate and polymeric compounds was not itself inhibited by the presence of the iron.

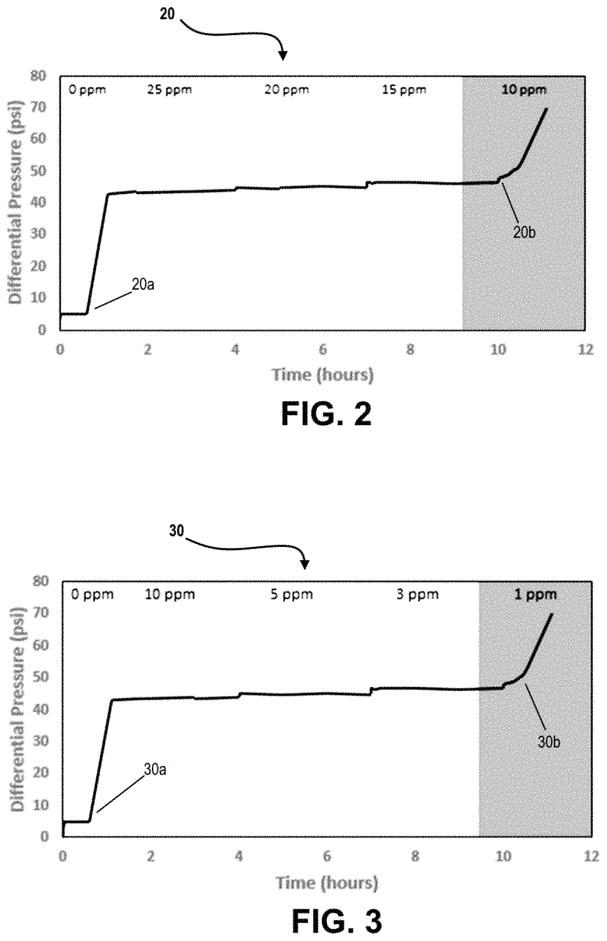

FIGS. 2 and 3 depict the performance over time of the ATMP compound, as measured by differential pressure (psi) with and without the sugar acid additive at various concentrations. FIG. 2 illustrates the performance of the standard ATMP compound 20 with a curve indicating a minimum inhibitor concentration (MIC) of around 15 ppm as indicated by the resumption 20b of the initial rise in pressure 20a. FIG. 3 illustrates the ATMP compound in conjunction with the sugar acid 30 with a curve indicating an MIC of around 3 ppm based on a similar resumption 30b of a stalled pressure increase 30a. The respective MIC values of 15 ppm and 3 ppm indicate a fivefold increase in effectiveness of the scale inhibitor in iron-rich environments.

While various embodiments of the present invention have been described with emphasis, and examples and test results described in detail, it should be understood that within the scope of the appended claims, the present invention may be practiced other than as specifically described herein.

1. A solution for inhibiting the deposition of mineral scales in an iron-rich brine comprising:
a scale inhibitor comprising a phosphonate or a polymeric compound, wherein the scale inhibitor is present at a concentration between 0.001 wt % and 99.999 wt %; and
an additive comprising a sugar acid or a precursor compound thereof, wherein the additive is present at a concentration between 0.0001% to 99.99 wt %.

2. The solution of claim 1, wherein the iron-rich brine contains dissolved iron at a concentration between 0.1 ppm and 10,000 ppm.

3. The solution of claim 1, wherein the additive comprises a sugar acid, wherein the sugar acid is aldonic acid, ulosonic acid, uronic acid, aldaric acid, or combinations thereof.

4. The solution of claim 1, wherein the additive comprises a precursor compound of a sugar acid, wherein the precursor compound is a salt, ester, or ether of aldonic acid, ulosonic acid, uronic acid, or aldaric acid, or combinations thereof.

5. The solution of claim 1, wherein the solution further comprises a corrosion inhibitor, iron control, surfactant, breaker, or biocide as a liquid well treatment agent, or in a solid composite of well treatment agents.

6. The solution of claim 1, wherein the scale inhibitor and the additive are present in a ratio between 2000:1 by weight and 1:2000 by weight, respectively.

7. A method of treating an oil or gas production system comprising blending a scale inhibitor with a sugar acid of the general formula: 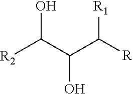
wherein R comprises COOH, R₁ comprises H, OH, O, NH, or NH₂, and R₂ comprises O or COOH, and wherein the blend comprising the sugar acid and the scale inhibitor is placed in the oil or gas production system to inhibit the deposition of scales comprising hydroxides, bicarbonates, sulfates, or carbonates of calcium, barium, strontium, iron, or a mixture thereof.

8. The method of claim 7, wherein the production system contains an aqueous fluid having a concentration between about 0.1 ppm and about 10,000 ppm of dissolved iron.

9. The method of claim 7, wherein the oil or gas production system is an injection well, salt water disposal well, or transmission pipeline.

10. The method of claim 7, wherein the scale inhibitor is a phosphonate or polymeric scale inhibitor.

11. The method of claim 7, wherein the sugar acid and scale inhibitor are blended in a ratio of between 2000:1 and 1:2000 by weight, respectively.
